(19) United States
(12) Patent Application Publication
(10) Pub. No.: US 2026/0057272 A1
(43) Pub. Date: Feb. 26, 2026

(54) METHOD FOR ASSERTING QUANTUM CIRCUIT DURING RUNTIME

(71) Applicant: National Taiwan University, Taipei City (TW)

(72) Inventors: Jie-Hong CHIANG, Taipei City (TW); Tian-Fu CHEN, Taipei City (TW); Chun-Yu WEI, Taipei City (TW)

(73) Assignee: National Taiwan University, Taipei City (TW)

(21) Appl. No.: 18/736,745

(22) Filed: Jun. 7, 2024

(51) Int. Cl. G06N 10/40; G06N 10/20

(52) U.S. Cl. CPC G06N 10/40; G06N 10/20

(57) ABSTRACT

A method for performing quantum computing on a quantum system using a quantum circuit with runtime assertion is provided. The quantum system includes a set of main qubits and a first ancilla qubit. A first circuit section of the quantum circuit changes the main qubits from an initial state to a first state. An assertion circuit detects whether the first state is erroneous based on a zero-amplitude set, and uses the first ancilla qubit to indicate a result of detecting whether the first state is erroneous, where the zero-amplitude set includes a set of predefined zero-amplitude state components. A second circuit section of the quantum circuit changes the main qubits from the first state to a second state when the first ancilla qubit indicates that the first state is not erroneous.

### FIELD

The disclosure relates to a method for asserting a quantum circuit during runtime, and more particularly to a method for asserting a quantum circuit based on a vanishing-state-based framework.

### BACKGROUND

Quantum circuit verification can be classified into static verification (in the quantum circuit design/synthesis phase) and dynamic verification (in the quantum circuit execution phase). Assertion is a common technique widely used in hardware design and software development, and dynamic verification for a quantum circuit is usually done by assertion during runtime (i.e., runtime assertion).

Conventional runtime assertion methods for verifying the quantum circuit are limited to asserting specific quantum states of the quantum circuit or generating assertion circuits on a case-by-case basis. Thus, the conventional runtime assertion methods have limited flexibility for verifying quantum circuits in a more general setting.

### SUMMARY

Therefore, an object of the disclosure is to provide a method for performing quantum computing on a quantum system using a quantum circuit with runtime assertion, and a quantum circuit structure that can alleviate at least one of the drawbacks of the prior art.

According to an aspect of the disclosure, a method for performing quantum computing on a quantum system using a quantum circuit with runtime assertion is provided. The quantum system includes a set of main qubits and a first ancilla qubit. The method includes: by a first circuit section of the quantum circuit, changing the main qubits from an initial state to a first state; by an assertion circuit, detecting whether the first state is erroneous based on a zero-amplitude set, and using the first ancilla qubit to indicate a result of detecting whether the first state is erroneous; and by a second circuit section of the quantum circuit, changing the main qubits from the first state to a second state when the first ancilla qubit indicates that the first state is not erroneous, wherein the zero-amplitude set includes a set of predefined zero-amplitude state components.

According to another aspect of the disclosure, a quantum circuit structure adapted for a quantum system is provided. The quantum system includes a set of main qubits and a first ancilla qubit. The quantum circuit structure includes a quantum circuit and an assertion circuit. The quantum circuit includes a first circuit section configured to change the main qubits from an initial state to a first state, and a second circuit section. The assertion circuit is between the first circuit section and the second circuit section, and is configured to detect whether the first state is erroneous based on a zero-amplitude set, and to indicate, using the first ancilla qubit, a result of detecting whether the first state is erroneous. The second circuit section is configured to change the main qubits from the first state to a second state when the first ancilla qubit indicates that the first state is not erroneous. The zero-amplitude set includes a set of predefined zero-amplitude state components.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a quantum circuit structure according to a first embodiment of the disclosure.

FIG. 2 is a block diagram illustrating the quantum circuit structure according to a second embodiment of the disclosure.

FIG. 3 is a flow chart illustrating a first procedure for obtaining a zero-amplitude set according to an embodiment of the disclosure.

FIG. 4 is a flow chart illustrating a second procedure for identifying an asserting position of a quantum circuit according to an embodiment of the disclosure.

FIG. 5 is a flow chart illustrating a method for performing quantum computing on the quantum system using the quantum circuit with runtime assertion according to the second embodiment of the disclosure.

FIG. 6 is a flow chart illustrating an amplitude-cancellation procedure according to the second embodiment of the disclosure.

FIG. 7 is a flow chart illustrating a neighbor-coupling procedure according to a third embodiment of the disclosure.

FIG. 8 is a flow chart illustrating the neighbor-coupling procedure according to a fourth embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

A quantum computer includes a plurality of qubits and means for manipulating a quantum state of the qubits. The quantum state of the qubits can be generally represented by

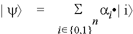

where |ψ [symbol] represents the quantum state of the qubits, n represents a quantity of the qubits, each |i [symbol] is a basis state component of the quantum state, and αᵢ are probability amplitudes. The basis state components represent possible quantum states of the qubits, and the probability amplitudes are associated with probabilities of occurrence of the possible quantum states, respectively.

To compute on the quantum computer, a quantum circuit that includes a series of quantum gates is applied to the quantum computer, where each of the quantum gates includes instructions to be performed by the means to manipulate the quantum state of the qubits, thereby changing the probability amplitudes of the basis state components. In one example, when the qubits are in a form of trapped ions, the quantum gates are configured to instruct a microwave device of the quantum computer to emit microwaves so as to manipulate the quantum state of the qubits.

Since the quantum computer in the noisy intermediate-scale quantum (NISQ) era is sensitive to noises, errors may occur in the quantum state of the qubits during runtime (i.e., during execution of the quantum circuit on the quantum computer). Therefore, early error detection during runtime may be helpful to reduce invalid experimental runs of the execution.

The disclosure is based on the observation that the quantum state of a quantum system may, at some point during runtime, contain some basis state components with zero probability amplitude (i.e., zero-amplitude state components, or vanishing states). Therefore, by monitoring the zero-amplitude state components in the quantum state, the quantum state may be determined as erroneous if one of the zero-amplitude state components results in a non-zero probability amplitude.

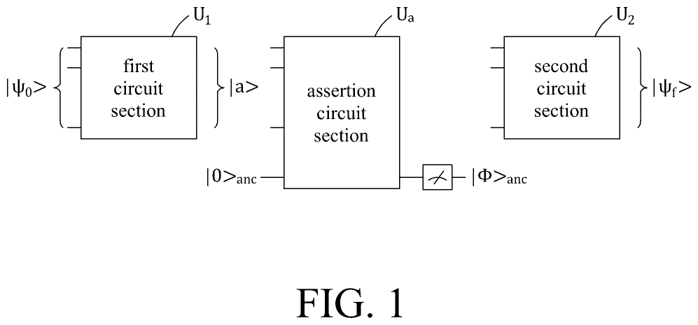

Referring to FIG. 1, a quantum circuit structure adapted for a quantum system according to a first embodiment of the disclosure is provided. The quantum system is the quantum computer, and includes a set of main qubits and a first ancilla qubit.

In the first embodiment, the quantum circuit structure includes a quantum circuit and an assertion circuit Uₐ. The quantum circuit includes a first circuit section U₁ and a second circuit section U₂. The first circuit section U₁ is configured to change the quantum state of the main qubits from an initial state |ψ₀ [symbol] to a first state |a [symbol] . The assertion circuit Uₐ is configured to detect whether the first state is erroneous based on a zero-amplitude set, and to indicate, using the first ancilla qubit, a result of detecting whether the first state is erroneous. The second circuit section U₂ is configured to change the quantum state of the main qubits from the first state to a second state |ψ_{f} [symbol] when the first ancilla qubit indicates that the first state is not erroneous. It should be noted that the zero-amplitude set includes a set of predefined zero-amplitude state components, and a first procedure for obtaining the zero-amplitude set will be described later in the disclosure. The first ancilla qubit has an initial value being a first value, and is changed to a second value when the first state is determined to be erroneous.

In one example, the quantum circuit includes a plurality of predetermined quantum gates assigned by a user for performing quantum computing based on the user needs. The assertion circuit Uₐ is inserted between the first circuit section U₁ and the second circuit section U₂ to perform runtime assertion, and is configured to operate as a unitary operator satisfying

$${{U}_{a} ( \vert i 〉 ⊗ 10 〉}_{a n c} ) = \{ \begin{matrix}{\vert i 〉 ⊗ \vert 1 〉}_{anc} , & if i ∈ S ( \vert ψ 〉 ) \\ {\vert i 〉 ⊗ \vert 0 〉}_{anc} , & otherwise\end{matrix} ,$$

where Uₐ is the assertion circuit, |i [symbol] is a basis state component of the first state of the main qubits, |0 [symbol] anc represents that the first ancilla qubit is in a state of |0 [symbol] , |1 [symbol] _{anc} represents that the first ancilla qubit is in a state of |1 [symbol] , and S(|ψ [symbol] ) is the zero-amplitude set. The first ancilla qubit indicates that the basis state component |i [symbol] of the first state is not erroneous when the first ancilla qubit is in the state of |0 [symbol] , and indicates that the basis state component |i [symbol] of the first state is erroneous when the first ancilla qubit is in the state of |1 [symbol] . To describe in further detail, the first ancilla qubit has an initial value of zero (i.e., the first value is equal to zero in this example). The assertion circuit Uₐ is configured to, when the assertion circuit Uₐ determines that one of multiple basis state components of the first state that has non-zero probability amplitude is included in the zero-amplitude set (i.e., if i∈S(|ψ [symbol] )), change the first ancilla qubit to one (i.e., the second value is equal to one in this example) so as to indicate that the one of multiple basis state components of the first state is erroneous; otherwise, the first ancilla qubit remains zero so as to indicate that the one of multiple basis state components of the first state is not erroneous. The resulting state of the first ancilla qubit is denoted as |Φ [symbol] _{anc} in FIG. 1. It should be noted that the state of the first ancilla qubit (i.e., |Φ [symbol] _{anc}) is in a superposition of |0 [symbol] and |1 [symbol] (i.e., the first ancilla qubit is either |0 [symbol] or |1 [symbol] for different basis state components of the first state), and detecting whether the first state is erroneous is carried out by measuring the state of the first ancilla qubit; therefore, the assertion circuit Uₐ may only probabilistically detect error in the quantum circuit.

In some embodiments, the first ancilla qubit is in the state of |1 [symbol] initially, and the first ancilla qubit indicates that the basis state component |i [symbol] of the first state is not erroneous when the first ancilla qubit is in the state of |1 [symbol] , and indicates that the basis state component |i [symbol] of the first state is erroneous when the first ancilla qubit is in the state of |0 [symbol] . It should be noted that the first ancilla qubit may be initialized to any initialized state based on user preference, as long as the first ancilla qubit is in a different state than the initialized state when an error is detected.

It should be noted that, in this embodiment, the assertion circuit Uₐ is a Boolean oracle circuit, and is generated based on an exclusive-or-sum-of-product (ESOP) based synthesis. In this disclosure, the first state and the zero-amplitude set may be obtained based on, for example, the binary decision diagram (BDD)-based SliQSim and SliQEC framework, but this disclosure is not limited in this aspect.

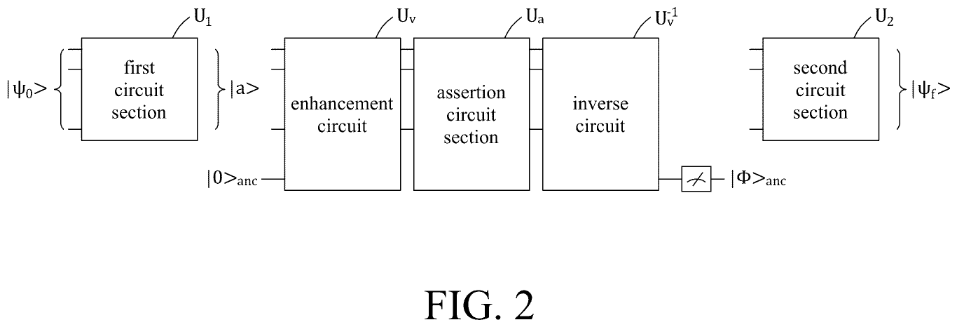

Referring to FIG. 2, the quantum circuit structure according to a second embodiment of the disclosure is similar to the first embodiment, and further includes an enhancement circuit Uᵥ and an inverse circuit

$${U}_{v}^{- 1}$$

The enhancement circuit Uᵥ is configured to increase a quantity of zero-amplitude state components in the first state (i.e., to increase a sparsity of the first state) so as to obtain an enhanced first state. As such, there is a higher chance for the assertion circuit Uₐ to detect error in the enhanced first state since there are more zero-amplitude state components to be monitored. The inverse circuit

$${U}_{v}^{- 1}$$

is configured to revert the enhanced first state to the first state for the second circuit section U₂ to use. That is to say, when the operations of the enhancement circuit Uᵥ and the inverse circuit

$${U}_{v}^{- 1}$$

are represented by matrices, the operation of the inverse circuit

$${U}_{v}^{- 1}$$

is an inverse matrix of the enhancement circuit Uᵥ. The enhancement circuit Uᵥ is inserted between the first circuit section U₁ and the assertion circuit Uₐ, and the inverse circuit

$${U}_{v}^{- 1}$$

is inserted between the assertion circuit Uₐ and the second circuit section U₂.

In the second embodiment, the assertion circuit Uₐ is configured to detect whether the first state is erroneous based on the enhanced first state and the zero-amplitude set.

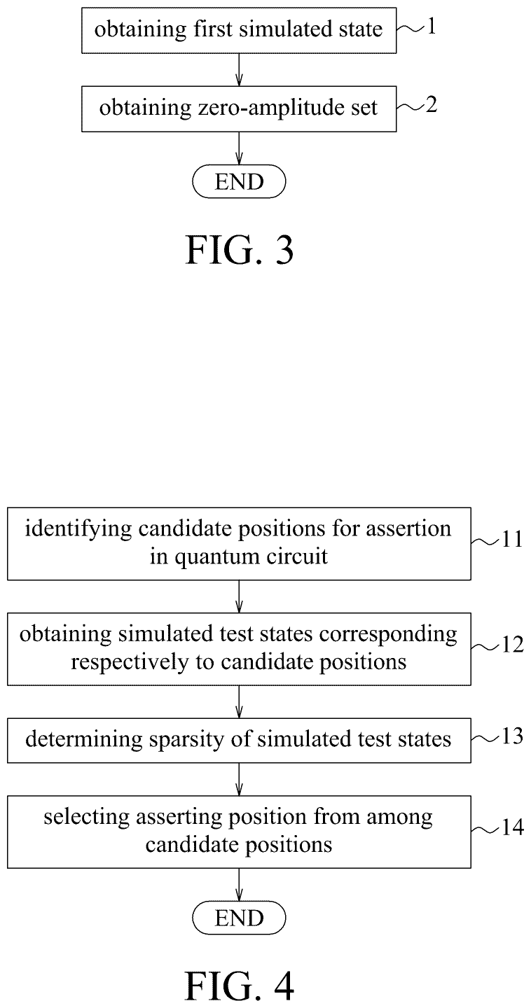

Further referring to FIG. 3, a first procedure for obtaining the zero-amplitude set is performed by a processor of a classical computer, and includes steps 1 and 2.

In step 1, the processor performs circuit simulation based on the initial state of the main qubits and the first circuit section U₁ for the first embodiment or based on the initial state of the main qubits, the first circuit section U₁, and the enhancement circuit Uᵥ for the second embodiment, so as to obtain a first simulated state of the main qubits. That is to say, the processor simulates the quantum circuit's operations on the main qubits using classical bits of the classical computer instead. As such, the first simulated state represents the error-free first state of the main qubits after being applied with the first circuit section U₁ (for the first embodiment) or further with the enhancement circuit Uᵥ (for the second embodiment).

In step 2, the processor identifies and sets those of basis state components in the first simulated state whose probability amplitudes are zero to be the predefined zero-amplitude state components, so as to obtain the zero-amplitude set, and the flow of the first procedure ends.

To describe in further detail, the processor obtains the zero-amplitude set as

$$S ( \vert ψ 〉 ) = \{ \vert i 〉 \vert {α}_{i} = 0 \} ,$$

and the sparsity of the quantum state |ψ [symbol] is a ratio of

$$\frac{\vert S ( \vert ψ 〉 ) \vert}{{2}^{n}} ,$$

where n represents the quantity of the main qubits.

In this embodiment, the processor of the classical computer may be, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), and/or a system on a chip (SoC), etc.

Referring further to FIG. 4, a second procedure for identifying an asserting position of the quantum circuit for the assertion circuit Uₐ to be inserted thereto is provided. The assertion circuit Uₐ is inserted at the asserting position to divide the quantum circuit into the first circuit section U₁ and the second circuit section U₂. The second procedure is performed by the processor, and includes steps 11 to 14.

In step 11, the processor identifies a plurality of candidate positions for assertion in the quantum circuit. Considering each of the candidate positions individually, the quantum circuit is divided into a first candidate section that is before the candidate position, and a second candidate section that is after the candidate position.

In step 12, for each of the candidate positions, the processor performs circuit simulation based on the initial state of the main qubits and the first candidate section that is before the candidate position, so as to obtain a simulated test state of the main qubits that corresponds to the candidate position.

Subsequently, the processor may determine, for each of the candidate positions, a cost or effectiveness of the candidate position for inserting the assertion circuit at the candidate position, and the processor or the user may select the asserting position from the candidate positions based on the cost and/or the effectiveness of each of the candidate positions. In this embodiment, the processor evaluates the cost or the effectiveness of the candidate position based on a sparsity of the simulated test state determined by the processor for each of the candidate positions in step 13.

In step 14, the processor selects the asserting position from the candidate positions based on the sparsity of each of the simulated test states that respectively correspond to the candidate positions, and the flow of the second procedure ends.

To describe in further detail, for each of the candidate positions and based on the sparsity of the simulated test state corresponding to the candidate position, the processor calculates a success rate and an expected execution time, which are related to the cost or the effectiveness of the candidate position. The success rate and the expected execution time are defined in terms of the second state generated by a combination of the quantum circuit and the assertion circuit being accurate when the asserting position is the candidate position. Specifically, the success rate and the expected execution time (which is positively correlated to an expected number of applied quantum gates) are respectively calculated by

$$\begin{matrix}{SR}_{w /} = \frac{{p}^{\vert {U}_{1} \vert + \vert {U}_{{a}^{′}} \vert + \vert {U}_{2} \vert}}{{p}^{\vert {U}_{1} \vert + \vert {U}_{ar} \vert} + ( 1 - {p}^{\vert {U}_{1} \vert + \vert {U}_{{a}^{′}} \vert} ) ( 1 - {D}_{r} )} , and \\ {E ( {n}_{G} )}_{w /} = \frac{\vert {U}_{1} \vert + \vert {U}_{{a}^{′}} \vert + \vert {U}_{2} \vert ( 1 - ( 1 - {p}^{\vert {U}_{1} \vert + \vert {U}_{ar} \vert} ) {D}_{r} )}{{p}^{\vert {U}_{1} \vert + \vert {U}_{ar} \vert + \vert {U}_{2} \vert}} ,\end{matrix}$$

where SR_{w}/represents the success rate of the quantum circuit with the assertion, E(n_{G})_{w/} represents the expected number of applied quantum gates of the quantum circuit with the assertion, each of the applied quantum gates is assumed to have the same probability p to be executed without error (i.e., a single-gate error rate is 1−p),

$${U}_{{a}^{′}} = {U}_{v}^{- 1} \times {U}_{a} \times {U}_{v} ,$$

and Dᵣ is an error detection rate of the assertion circuit Uₐ. It is noted that the above two equations use a notation of |U| to denote a gate count of a quantum circuit U, so |U₁|denotes a gate count of the first circuit section of the quantum circuit U₁, and this logic can be applied to other similar cases, such as |U₁|, |Uₐ|, etc. The sparsity of the simulated test state can be used as an estimate for the error detection rate Dᵣ and can thus be used to calculate the success rate and the expected execution time.

In some embodiments, the user may choose the asserting position based on how high the user wants the success rate to be, how low the user wants the expected execution time to be, or a desired balance between the success rate and the expected execution time. In some embodiments, the asserting position may be predetermined by the user, such as at the center of the quantum circuit.

In some embodiments, there may be more than one assertion circuit Uₐ, and in such a case, the processor may select multiple asserting positions from the candidate positions. As a result, the quantum circuit would be divided into more circuit sections depending on the number of the asserting positions.

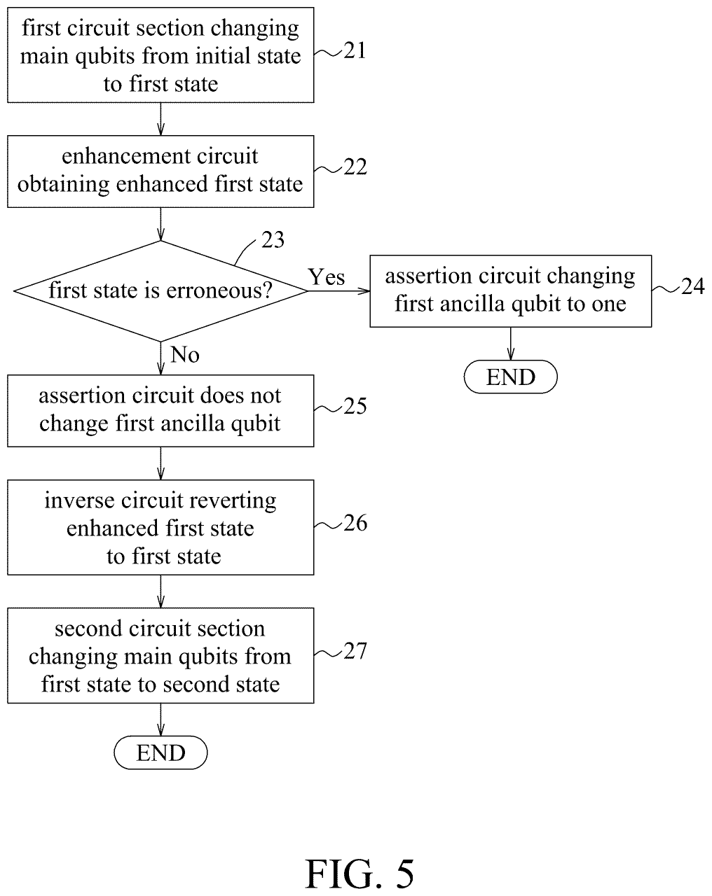

Referring to FIGS. 2 and 5, a method for performing quantum computing on the quantum system using the quantum circuit with runtime assertion according to the second embodiment of the disclosure is provided. The method is performed by the quantum circuit structure, and includes steps 21 to 27.

In step 21, the first circuit section U₁ of the quantum circuit changes the quantum state of the main qubits from the initial state to the first state.

In step 22, the enhancement circuit Uᵥ increases the quantity of zero-amplitude state components in the first state so as to obtain the enhanced first state. Details of step 22 will be described later in the disclosure.

In step 23, the assertion circuit Uₐ detects whether the first state is erroneous based on the enhanced first state and the zero-amplitude set that is obtained in the first procedure. When the assertion circuit Uₐ detects that the first state is erroneous, the flow proceeds to step 24; otherwise, the flow proceeds to step 25.

In step 24, the assertion circuit Uₐ changes the first ancilla qubit to one so as to indicate that the first state is erroneous, and the flow of the method ends. That is to say, the execution of the quantum circuit on the quantum system is aborted, thereby saving time from continuing to execute the inverse circuit

$${U}_{v}^{- 1}$$

and the second circuit section U₂.

In step 25, the assertion circuit Uₐ does not change the first ancilla qubit so that the first ancilla qubit remains zero so as to indicate that the first state is not erroneous, and the flow proceeds to step 26.

In step 26, the inverse circuit

$${U}_{v}^{- 1}$$

reverts the enhanced first state to the first state.

In step 27, the second circuit section U₂ of the quantum circuit changes the quantum state of the main qubits from the first state to the second state, thereby completing execution of the quantum circuit on the quantum system. The flow of the method ends after step 27.

In a case where the quantum circuit structure does not include the enhancement circuit Uᵥ and the inverse circuit

$${U}_{v}^{- 1} ,$$

such as in the first embodiment, steps 22 and 26 are omitted, and the flow proceeds to step 27 after step 25.

The first state |a [symbol] of the main qubits can be represented in a form of a state vector that includes a plurality of vector components α₀ to a₂_{ⁿ}₋₁ and that is expressed as follows:

$$\vert a 〉 = {[ {α}_{0} , {α}_{1} , … , {α}_{{2}^{n} - 1} ]}^{T} ,$$

where n represents a quantity of the main qubits. For each k∈{0, 1, . . . , 2ⁿ−1}, a vector component αₖ represents a probability amplitude of a basis state component |k [symbol] of the first state, the basis state component |k [symbol] is expressed in binary having n bits, and each of which the n bits corresponds to a respective one of the main qubits.

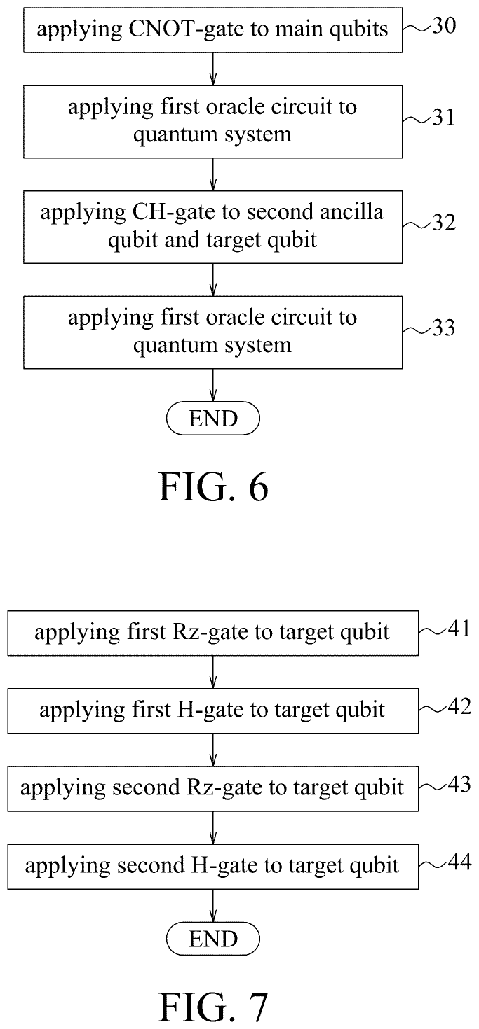

Referring further to FIG. 6, in the second embodiment of the disclosure, the enhancement circuit Uᵥ is configured to obtain the enhanced first state using an amplitude-cancellation procedure in step 22, and the quantum system further includes a second ancilla qubit that has an initial value of zero.

Prior to performing the amplitude-cancellation procedure, the basis state components of the first state |a [symbol] are categorized into three different categories by the processor: a candidate pair category, an excluded pair category, and a don't care category.

The basis state components in the candidate pair category correspond to at least one first pair of vector components (αₚ, α_{q}), where a first vector component aₚ and a second vector component α_{q} of each of the at least one first pair of vector components (αₚ, α_{q}) come from the vector components α₀ to α₂_{ⁿ}₋₁ of the state vector |a [symbol] . The first vector component αₚ is either equal to or opposite to the second vector component α_{q} (i.e., αₚ=α_{q} or αₚ=−α_{q}), p differs from q at only one bit position when p and q are expressed in binary, and the only one bit position at which p differs from q corresponds to a target qubit, which is one of the main qubits.

The basis state components in the excluded pair category correspond to at least one second pair of vector components (αᵣ, αₛ), where a third vector component αᵣ and a fourth vector component as of each of the at least one second pair of vector components (αᵣ, αₛ) come from the vector components α₀ to α₂_{ⁿ}₋₁ of the state vector |a [symbol] . Furthermore, r differs from s at the only one bit position at which p differs from q when r and s are expressed in binary, and exactly one of the third vector component αᵣ and the fourth vector component αₛ is equal to zero. However, it is possible that the excluded pair category is empty (i.e., no such second pair of vector components (αᵣ, αₛ) exists in the state vector |a [symbol] ). The basis state components in the don't care category correspond to all other vector components that are neither in the candidate pair category nor in the excluded pair category.

The processor determines the three different categories, and generates the enhancement circuit Uᵥ based on the three different categories such that the enhancement circuit Uᵥ is configured to perform the amplitude-cancellation procedure. In the second embodiment, the amplitude-cancellation procedure includes steps 31 to 33.

In step 31, the enhancement circuit Uᵥ applies a first oracle circuit to the quantum system so as to set the second ancilla qubit to one for those of the basis state components of the first state |a [symbol] in the candidate pair category, and to set the second ancilla qubit to zero for those of the basis state components of the first state |a [symbol] in the excluded pair category.

To describe in further detail, the first oracle circuit is configured to operate as a unitary operator satisfying

$${{U}_{o 1} ( \vert k 〉 ⊗ \vert 0 〉}_{anc} ) = \{ \begin{matrix}{\vert k 〉 ⊗ \vert 1 〉}_{anc} , & if k ∈ F \\ {\vert k 〉 ⊗ \vert 0 〉}_{anc} , & if k ∈ G\end{matrix} ,$$

where Uₒ₁ is the first oracle circuit, |k [symbol] is a basis state component of the first state of the main qubits, |0 [symbol] _{anc} represents that the second ancilla qubit is in a state of |0 [symbol] , |1 [symbol] _{anc} represents that the second ancilla qubit is in a state of |1 [symbol] , “F” is a set of those of the basis state components in the candidate pair category, and “G” is a set of those of the basis state components in the excluded pair category. In this embodiment, the first oracle circuit is another Boolean oracle circuit.

It should be noted that, for those of the basis state components of the first state |a [symbol] in the don't care category, the first oracle circuit is not restricted to set the second ancilla qubit to one or zero, and thus the first oracle circuit may be generated by the processor using less processing power by allowing the first oracle circuit to not be restricted to set the second ancilla qubit to one or zero for those of the basis state components of the first state |a [symbol] in the don't care category.

In step 32, the enhancement circuit Uᵥ applies a controlled Hadamard gate (CH-gate) to the second ancilla qubit and the target qubit with the second ancilla qubit serving as a control qubit, so as to change one of the first vector component αₚ and the second vector component α_{q} to zero for each of the at least one first pair of vector components (αₚ, α_{q}). As such, more zero-amplitude state components are created in the first state, and the enhanced first state is obtained.

In some embodiments, some of the basis state components of the first state |a [symbol] that are either in the candidate pair category or in the excluded pair category may be treated as the don't care category. That is to say, the first oracle circuit is not restricted to set the second ancilla qubit to one or zero for those of the basis state components of the first state |a [symbol] that are treated as the don't care category. As such, the first oracle circuit may be generated by the processor using even less processing power, but may not be as efficient in creating the zero-amplitude state components as when actively setting the second ancilla qubit to one for the candidate pair category and setting the second ancilla qubit to zero for the excluded pair category.

In step 33, the enhancement circuit Uᵥ applies the first oracle circuit again so as to revert the second ancilla qubit to zero for reuse, and the flow of the amplitude-cancellation procedure ends.

In some embodiments, in a case where the user desires more basis state components to be in the candidate pair category, the basis state components that correspond to at least one third pair of vector components (αₓ, α_{y}) are identified, where a fifth vector component αₓ and a sixth vector component α_{y} come from the vector components α₀ to α₂_{ⁿ}₋₁, the fifth vector component αₓ is either equal to or opposite to the sixth vector component α_{y}, and x differs from y at multiple bit positions when x and y are expressed in binary. In such case, the amplitude-cancellation procedure further includes step 30 before steps 31 to 33.

In step 30, the enhancement circuit Uᵥ applies at least one controlled NOT gate (CNOT-gate) to the main qubits to reduce a Hamming distance between x and y to one (i.e., to make x differ from y at only one bit position when x and y are expressed in binary), so as to create more of the first pair of vector components (αₚ, α_{q}), namely, more basis state components in the candidate pair category.

To describe in further detail, each of the at least one CNOT-gate is applied to two of those of the main qubits that correspond to the multiple bit positions at which x differs from y, and a quantity of the at least one CNOT-gate is equal to the Hamming distance subtracted by one. Since reducing the Hamming distance using the CNOT-gate is well known to a person having ordinary skill in the art, it will not be described in further detail for the sake of brevity.

In practice, steps 31 to 33 or steps 30 to 33 may be repeated until no more first pair of vector components (αₚ, α_{q}) can be found, so as to create more zero-amplitude state components in the first state.

It should be noted that the second ancilla qubit may be omitted in the amplitude-cancellation procedure, and a Hadamard gate (H-gate) may be directly applied to the target qubit for those of the basis state components that are selected by the user (e.g., those of the basis state components in the candidate pair category). Similarly, the user may refrain from applying the H-gate to some of the basis state components (e.g., those of the basis state components in the excluded pair category), but the disclosure is not limited to such.

Referring further to FIG. 7, a third embodiment of the disclosure is similar to the second embodiment, but their difference resides in that the enhancement circuit Uᵥ in the third embodiment is configured to obtain the enhanced first state using a neighbor-coupling procedure in step 22. The neighbor-coupling procedure includes steps 41 to 44.

In step 41, the enhancement circuit Uᵥ applies a first z-axis rotation gate (R_{z}-gate) to a target qubit based on a first angle θₐᵢ, where the target qubit is one of the main qubits. In the following example, the first angle θₐᵢ corresponds to a pair of vector components (α₂ᵢ, α₂ᵢ₊₁) that come from the vector components α₀ to α₂_{ⁿ}₋₁ of the state vector |ψ [symbol] , so the target qubit corresponds to the least significant bit when the basis state components of the first state are expressed in binary, where i is an integer from zero to 2⁽ⁿ⁻¹⁾−1. However, this neighbor-coupling procedure is applicable to any one of the main qubits, and this disclosure is not limited in this aspect.

To describe in further detail, the first angle θₐᵢ is obtained as

$${θ}_{ai} = {∠α}_{2 i} - {∠α}_{2 i + 1} - \frac{π}{2} ,$$

such that the pair of vector components (α₂ᵢ, α₂ᵢ₊₁) after being applied with the first R_{z}-gate becomes (α₂ᵢ′, α₂ᵢ₊₁′), where α₂ᵢ′ is orthogonal to α₂ᵢ₊₁′ on a complex plane.

In step 42, the enhancement circuit Uᵥ applies a first Hadamard gate (H-gate) to the target qubit, so that the pair of vector components (α₂ᵢ′,α₂ᵢ₊₁′) becomes (a₂ᵢ″,α₂ᵢ₊₁″), where

$$\vert {α}_{2 i}^{″} \vert = \vert {α}_{2 i + 1}^{″} \vert .$$

In step 43, the enhancement circuit Uᵥ applies a second R_{z}-gate to the target qubit based on a second angle θ_{bi} that corresponds to the pair of vector components (α₂ᵢ, α₂ᵢ₊₁).

To describe in further detail, the second angle θ_{bi} is obtained as

$${θ}_{bi} = ∠ {α}_{2 i}^{″} - ∠ {α}_{2 i + 1}^{″} + π ,$$

such that the pair of vector components (α₂ᵢ″, α₂ᵢ₊₁″) after being applied with the second R_{z}-gate becomes (α₂ᵢ″, α₂ᵢ₊₁′″), where

$${α}_{2 i}^{″} = - {α}_{2 i + 1}^{′′′} .$$

In step 44, the enhancement circuit Uᵥ applies a second H-gate to the target qubit, such that the vector component α₂ᵢ from the pair of vector components (α₂ᵢ, α₂ᵢ₊₁) is turned into zero. The flow of the neighbor-coupling procedure ends after step 44.

It should be noted that each of the first R_{z}-gate and the second R_{z}-gate is a multi-phase-multi-controlled-Rz gate such that each of the first R_{z}-gate and the second R_{z}-gate may be applied to the target qubit for one integer i at a time. Similarly, each of the first H-gate and the second H-gate is a multi-phase-multi-controlled-H-gate such that each of the first H-gate and the second H-gate may be applied to the target qubit for one integer i at a time.

It should be noted that since i is an integer from zero to 2⁽ⁿ⁻¹⁾−1 (i.e., steps 41 to 44 are performed for all i's from zero to 2⁽ⁿ⁻¹⁾−1), half of the basis state components in the first state are turned into zero-amplitude state components after the enhancement circuit Uᵥ performs the neighbor-coupling procedure.

In a case where more zero-amplitude state components are demanded by the user, steps 41 to 44 are repeated using another target qubit, and the neighbor-coupling procedure turns to manage some of the basis state components that correspond to, for example, a pair of vector components (α₄ᵢ₊₁, α₄ᵢ₊₃), which further turns the vector component α₄ᵢ₊₁ into zero. The neighbor-coupling procedure may be repeated to create more zero-amplitude state components in the first state according to the user requirements.

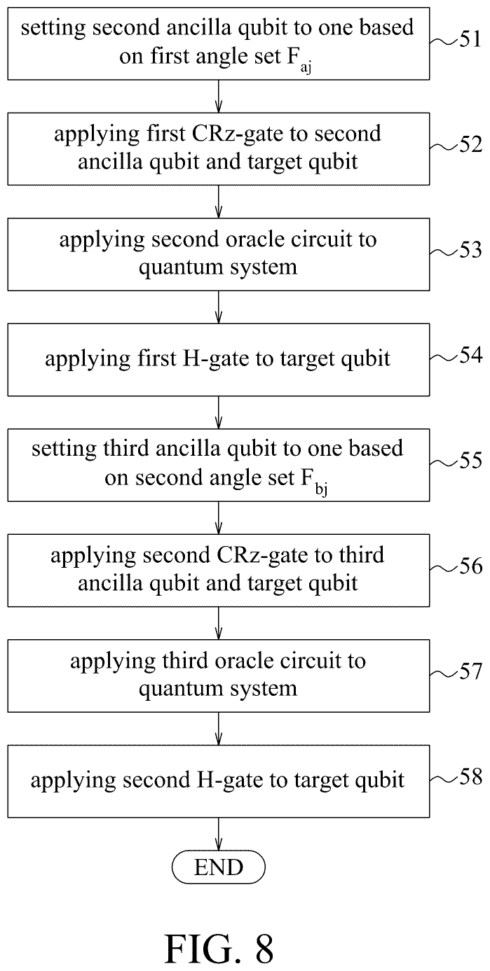

Referring further to FIG. 8, a fourth embodiment of the disclosure similar to the third embodiment is provided. In the fourth embodiment, the first angle θₐᵢ and the second angle θ_{bi} that correspond to the pair of vector components (α₂ᵢ, α₂ᵢ₊₁) are converted into a binary representation where

$${θ}_{ai} = {b}_{{ai}_{1}} \cdot \frac{2 π}{{2}^{1}} + {b}_{{ai}_{2}} \cdot \frac{2 π}{{2}^{2}} + ⋯ + {b}_{{ai}_{m}} \cdot \frac{2 π}{{2}^{m}} ,$$

$$and$$

$${θ}_{bi} = {b}_{{bi}_{1}} \cdot \frac{2 π}{{2}^{1}} + {b}_{{bi}_{2}} \cdot \frac{2 π}{{2}^{2}} + ⋯ + {b}_{{bi}_{m}} \cdot \frac{2 π}{{2}^{m}} ,$$

where i is an integer from zero to 2⁽ⁿ⁻¹⁾−1, m is a positive integer, and for each integer j from 1 to m, bₐᵢ_{ⱼ}∈{0, 1}, and b_{bi}_{ⱼ}∈{0, 1}.

In the fourth embodiment, the quantum system further includes a third ancilla qubit that has an initial value of zero, and the neighbor-coupling procedure includes steps 51 to 58. Specifically, steps 51 to 53 are performed for each integer j from 1 to m before performing step 54, and steps 55 and 57 are performed for each integer j from 1 to m before performing step 58.

In step 51, the enhancement circuit Uᵥ sets the second ancilla qubit to one for those of the basis state components of the first state that correspond to the pair of vector components (α₂ᵢ, α₂ᵢ₊₁) in response to bₐᵢ_{ⱼ}=1.

In step 52, the enhancement circuit Uᵥ applies a first controlled R_{z}-gate (CR_{z}-gate) based on an angle of

$$\frac{2 π}{{2}^{j}}$$

to the second ancilla qubit and the target qubit with the second ancilla qubit serving as a control qubit.

To describe in further detail, for each integer j, a first angle set Fₐⱼ that corresponds to the integer j is obtained by the processor in advance based on the first angle θₐᵢ in the binary representation, and is defined to be

$${F}_{aj} = \{ i \vert {b}_{{ai}_{j}} = 1 \} ,$$

where the i included in the first angle set Fₐⱼ indicates those of the basis state components of the first state that correspond to the pair of vector components (α₂ᵢ, α₂ᵢ₊₁), which are to be applied with the first CR_{z}-gate. The enhancement circuit Uᵥ performs step 51 by applying a second oracle circuit that is yet another Boolean oracle circuit corresponding to the first angle set Fₐⱼ.

To describe in further detail, the second oracle circuit is configured to perform

$${{U}_{o 2} ( \vert i 〉 ⊗ \vert 0 〉}_{anc} ) = \{ \begin{matrix}{\vert i 〉 ⊗ \vert 1 〉}_{anc} , & if i ∈ {F}_{aj} \\ {\vert i 〉 ⊗ \vert 0 〉}_{anc} , & otherwise\end{matrix} .$$

In step 53, the enhancement circuit Uᵥ applies the second oracle circuit again so as to revert the second ancilla qubit to zero for reuse.

In step 54, the enhancement circuit Uᵥ applies a first H-gate to the target qubit.

In step 55, the enhancement circuit Uᵥ sets the third ancilla qubit to one for those of the basis state components of the first state that correspond to the pair of vector components (α₂ᵢ, α₂ᵢ₊₁) in response to b_{bi}_{ⱼ}=1.

In step 56, the enhancement circuit Uᵥ applies a second CR_{z}-gate based on an angle of

$$\frac{2 π}{{2}^{j}}$$

to the third ancilla qubit and the target qubit with the third ancilla qubit serving as a control qubit.

To describe in further detail, steps 55 and 56 are performed in a similar manner as steps 51 and 52. For each integer j, a second angle set F_{bj} that corresponds to the integer j is obtained by the processor in advance based on the second angle θ_{bi} in the binary representation, and is defined to be

$${F}_{bj} = \{ i \vert {b}_{{bi}_{j}} = 1 \} ,$$

where the i included in the second angle set F_{bj} indicates those of the basis state components of the first state that correspond to the pair of vector components (α₂ᵢ, α₂ᵢ₊₁), which are to be applied with the second CR_{z}-gate. The enhancement circuit Uᵥ performs step 55 by applying a third oracle circuit that is yet another Boolean oracle circuit corresponding to the second angle set F_{bj}.

To describe in further detail, the third oracle circuit is configured to perform

$${{U}_{o 3} ( \vert i 〉 ⊗ \vert 0 〉}_{anc} ) = \{ \begin{matrix}{\vert i 〉 ⊗ \vert 1 〉}_{anc} , & if i ∈ {F}_{bj} \\ {\vert i 〉 ⊗ \vert 0 〉}_{anc} , & otherwise\end{matrix} .$$

In step 57, the enhancement circuit Uᵥ applies the third oracle circuit again so as to revert the third ancilla qubit to zero for reuse.

In step 58, the enhancement circuit Uᵥ applies a second H-gate to the target qubit, and the flow of the neighbor-coupling procedure ends.

It should be noted that the second ancilla qubit and the third ancilla qubit may be omitted in the neighbor-coupling procedure. In such a case, a first R_{z}-gate may be directly applied to the target qubit based on an angle of

$$\frac{2 π}{{2}^{j}}$$

for those of the basis state components that correspond to the pair of vector components (α₂ᵢ, α₂ᵢ₊₁) in response to bₐᵢ_{ⱼ}=1, and a second R_{z}-gate may be directly applied to the target qubit based on an angle of

$$\frac{2 π}{{2}^{j}}$$

for those of the basis state components that correspond to the pair of vector components (α₂ᵢ, α₂ᵢ₊₁) in response to b_{bi}_{ⱼ}=1.

It should be noted that, in both of the third embodiment and the fourth embodiment, the processor obtains the first angle θₐᵢ and the second angle θ_{bi} in advance based on the first simulated state, and generates the enhancement circuit Uᵥ such that the enhancement circuit Uᵥ is configured to perform the neighbor-coupling procedure.

Compared to the third embodiment, the R_{z}-gates in the fourth embodiment are based on the angle of

$$\frac{2 π}{{2}^{j}} ,$$

instead of on the first angle θₐᵢ and the second angle θ_{bi} for each of the pair of vector components (α₂ᵢ, α₂ᵢ₊₁). Therefore, the R_{z}-gates can be shared throughout the neighbor-coupling procedure in the fourth embodiment.

In some embodiments, the first ancilla qubit, the second ancilla qubit, and the third ancilla qubit may be the same ancilla qubit. In some embodiments, more than one ancilla qubits may be used during each procedure and/or method depending on hardware designs of the quantum computer.

It should be noted that the assertion circuit Uₐ may itself produce errors in the quantum state, and thus it may be desirable to reduce the size (i.e., number of quantum gates) of the assertion circuit Uₐ at the cost of a reduced error detection rate. The user may freely adjust the size of the assertion circuit Uₐ by ignoring some of the zero-amplitude state components, so that the assertion circuit Uₐ only monitors a portion of the zero-amplitude state components instead of all zero-amplitude state components in the quantum state. That is to say, the user may adjust the number of the zero-amplitude state components that are being ignored to obtain different trade-offs between the size of the assertion circuit Va and the error detection rate.

In summary, the quantum gate structure and the method provided in the disclosure are capable of detecting whether the quantum state is erroneous at the asserting position based on the zero-amplitude set, and using the first ancilla qubit to indicate whether the quantum state is erroneous. As such, the execution of the quantum circuit may be aborted upon detecting that the quantum system is erroneous during runtime, thus avoiding time wasted for continuing to execute the second circuit section U₂.

Moreover, compared to conventional methods which create a preprocessed assertion circuit for a specific quantum circuit, the quantum gate structure and the method provided in the disclosure provide a systematic way for asserting a quantum circuit in a more general setting by automatically detecting, utilizing, and creating zero-amplitude states in the quantum circuit for assertion if needed, and the size of the assertion circuit may be freely adjusted with different trade-offs in the error detection rate.

The disclosure further includes procedures to create or increase the number of zero-amplitude state components in the quantum system so as to ensure that the method can be performed properly. As such, the method may be applied to the quantum system even if the quantum system does not include any zero-amplitude state components at the asserting position.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for performing quantum computing on a quantum system using a quantum circuit with runtime assertion, the quantum system including a set of main qubits and a first ancilla qubit, the method comprising:
by a first circuit section of the quantum circuit, changing the main qubits from an initial state to a first state;
by an assertion circuit, detecting whether the first state is erroneous based on a zero-amplitude set, and using the first ancilla qubit to indicate a result of detecting whether the first state is erroneous; and
by a second circuit section of the quantum circuit, changing the main qubits from the first state to a second state when the first ancilla qubit indicates that the first state is not erroneous,
wherein the zero-amplitude set includes a set of predefined zero-amplitude state components.

2. The method as claimed in claim 1, further comprising setting the first ancilla qubit to a first value (v1) before the assertion circuit detects whether the first state is erroneous,
wherein, in the detecting of whether the first state is erroneous and the using of the first ancilla qubit to indicate a result of detecting, the assertion circuit operates as a unitary operator satisfying
$${{U}_{a} ( \vert i 〉 ⊗ \vert v 1 〉}_{anc} ) = \{ \begin{matrix}{\vert i 〉 ⊗ \vert v 2 〉}_{anc} , & if i ∈ S ( \vert ψ 〉 ) \\ {\vert i 〉 ⊗ \vert v 1 〉}_{anc} , & otherwise\end{matrix} ,$$
where Uₐ is the assertion circuit, |i [symbol] is a basis state component of the first state of the main qubits, |v1 [symbol] _{anc} represents that the first ancilla qubit is in a state of |v1 [symbol] , |v2 [symbol] _{anc} represents that the first ancilla qubit is in a state of |v2 [symbol] , v2 is a second value that is different from the first value (v1), and S(|ψ [symbol] ) is the zero-amplitude set; and
wherein the first ancilla qubit indicates that the basis state component |i [symbol] of the first state is not erroneous when the first ancilla qubit is in the state of |v1 [symbol] , and indicates that the basis state component |i [symbol] of the first state is erroneous when the first ancilla qubit is in the state of |v2 [symbol] .

3. The method as claimed in claim 1, further comprising:
by an enhancement circuit, increasing a quantity of zero-amplitude state components in the first state to obtain an enhanced first state; and
by an inverse circuit, reverting the enhanced first state to the first state for the second circuit section to use,
wherein the assertion circuit is applied to the quantum system after the enhancement circuit and before the inverse circuit, and detects whether the first state is erroneous based on the enhanced first state and the zero-amplitude set.

4. The method as claimed in claim 3, wherein the first state of the main qubits is represented by a state vector |α [symbol] that includes a plurality of vector components α₀ to α₂_{ⁿ}₋₁, where n represents a quantity of the main qubits, and
$$\vert a 〉 = {[ {α}_{0} , {α}_{1} , … , {α}_{{2}^{n} - 1} ]}^{T} ;$$
wherein for each k∈{0, 1, . . . , 2ⁿ−1}, a vector component αₖ represents a probability amplitude of a basis state component |k [symbol] , which is one of multiple basis state components of the first state, the basis state component |k [symbol] being expressed in binary having n bits, each of the n bits corresponding to a respective one of the main qubits; and
wherein the increasing of the quantity of zero-amplitude state components in the first state includes:
applying a Hadamard gate (H-gate) to a target qubit for those of the basis state components of the first state that correspond to a first pair of vector components (αₚ, α_{q}), wherein a first vector component αₚ and a second vector component α_{q} of the first pair of vector components (αₚ, α_{q}) come from the vector components α₀ to α₂_{ⁿ}₋₁ of the state vector |a [symbol] , the first vector component αₚ is either equal to or opposite to the second vector component α_{q}, p differs from q at only one bit position when p and q are expressed in binary, and the only one bit position at which p differs from q corresponds to a target qubit that is one of the main qubits, so as to change one of the first vector component αₚ and the second vector component α_{q} to zero.

5. The method as claimed in claim 4, wherein the increasing of the quantity of zero-amplitude state components in the first state includes:
refraining from applying the H-gate to the target qubit for those of the basis state components of the first state that correspond to a second pair of vector components (αᵣ, αₛ), wherein a third vector component αᵣ and a fourth vector component as of the second pair of vector components (αᵣ, αₛ) come from the vector components α₀ to α₂_{ⁿ}₋₁ of the state vector |a [symbol] , r differs from s at the only one bit position at which p differs from q when r and s are expressed in binary, and exactly one of the third vector component αᵣ and the fourth vector component as is equal to zero.

6. The method as claimed in claim 4, wherein the vector components do to α₂_{ⁿ}₋₁ includes a fifth vector component αₓ and a sixth vector component α_{y}, the fifth vector component αₓ is either equal to or opposite to the sixth vector component α_{y}, and x differs from y at multiple bit positions when x and y are expressed in binary; and
wherein the increasing of the quantity of zero-amplitude state components in the first state includes:
applying at least one controlled NOT gate (CNOT-gate) to the main qubits to reduce a Hamming distance between x and y to one, so as to create more of the first pair of vector components (αₚ, α_{q}).

7. The method as claimed in claim 3, wherein the first state of the main qubits is represented by a state vector |a [symbol] that includes a plurality of vector components α₀ to α₂_{ⁿ}₋₁, where n represents a quantity of the main qubits, and
$$\vert a 〉 = {[ {α}_{0} , {α}_{1} , … , {α}_{{2}^{n} - 1} ]}^{T} ;$$
wherein for each k∈{0, 1, . . . , 2ⁿ−1}, a vector component αₖ represents a probability amplitude of a basis state component |k [symbol] , which is one of multiple basis state components of the first state, the basis state component |k [symbol] being expressed in binary having n bits, each of the n bits corresponding to a respective one of the main qubits; and
wherein the increasing of the quantity of zero-amplitude state components in the first state includes:
applying a first z-axis rotation gate (R_{z}-gate) to a target qubit based on a first angle θₐᵢ, wherein the first angle θₐᵢ corresponds to a pair of vector components (α₂ᵢ, α₂ᵢ₊₁) that come from the vector components do to α₂_{ⁿ}₋₁ of the state vector |a [symbol] , i is an integer from zero to 2⁽ⁿ⁻¹⁾−1, and the target qubit is one of the main qubits;
applying a first H-gate to the target qubit;
applying a second R_{z}-gate to the target qubit based on a second angle θ_{bi} that corresponds to the pair of vector components (α₂ᵢ, α₂ᵢ₊₁); and
applying a second H-gate to the target qubit.

8. The method as claimed in claim 3, wherein the first state of the main qubits is represented by a state vector |a [symbol] that includes a plurality of vector components α₀ to α₂_{ⁿ}₋₁, where n represents a quantity of the main qubits, and
$$\vert a 〉 = {[ {α}_{0} , {α}_{1} , … , {α}_{{2}^{n} - 1} ]}^{T} ;$$
wherein for each k∈{0, 1, . . . , 2ⁿ−1}, a vector component αₖ represents a probability amplitude of a basis state component |k [symbol] , which is one of multiple basis state components of the first state, the basis state component |k [symbol] being expressed in binary having n bits, each of the n bits corresponding to a respective one of the main qubits;
wherein a pair of vector components (α₂ᵢ, α₂ᵢ₊₁) that come from the vector components α₀ to α₂_{^{n−1}} of the state vector |a [symbol] corresponds to a predetermined first angle θₐᵢ and a predetermined second angle θ_{bi},
$$where$$
$${θ}_{ai} = {b}_{{ai}_{1}} \cdot \frac{2 π}{{2}^{1}} + {b}_{{ai}_{2}} \cdot \frac{2 π}{{2}^{2}} + ⋯ + {b}_{{ai}_{m}} \cdot \frac{2 π}{{2}^{m}} ,$$
$$where$$
$${θ}_{bi} = {b}_{{bi}_{1}} \cdot \frac{2 π}{{2}^{1}} + {b}_{{bi}_{2}} \cdot \frac{2 π}{{2}^{2}} + ⋯ + {b}_{{bi}_{m}} \cdot \frac{2 π}{{2}^{m}}$$
and where i is an integer from zero to 2⁽ⁿ⁻¹⁾−1, m is a positive integer, and for each integer j from 1 to m, bₐᵢ_{ⱼ}∈{0, 1}, and b_{bi}_{ⱼ}={0, 1}; and
wherein the increasing of the quantity of zero-amplitude state components in the first state includes:
for each integer j from 1 to m, applying a first R_{z}-gate to a target qubit based on an angle of
$$\frac{2 π}{{2}^{j}}$$
for those of the basis state components of the first state that correspond to the pair of vector components (α₂ᵢ, α₂ᵢ₊₁) in response to bₐᵢ_{ⱼ}=1, wherein the target qubit is one of the main qubits;
applying a first H-gate to the target qubit;
for each integer j from 1 to m, applying a second R_{z}-gate to the target qubit based on an angle of
$$\frac{2 π}{{2}^{j}}$$
for those of the basis state components of the first state that correspond to the pair of vector components (α₂ᵢ, α₂ᵢ₊₁) in response to b_{bi}_{ⱼ}=1; and
applying a second H-gate to the target qubit.

9. The method as claimed in claim 1, comprising:
by a processor, performing circuit simulation based on the initial state of the main qubits and the first circuit section so as to obtain a first simulated state of the main qubits; and
by the processor, identifying and setting those of basis state components of the first simulated state whose probability amplitudes are zero to be the predefined zero-amplitude state components, so as to obtain the zero-amplitude set.

10. The method as claimed in claim 9, wherein the assertion circuit is inserted at an asserting position of the quantum circuit to divide the quantum circuit into the first circuit section and the second circuit section, and said method comprises:
by the processor, identifying a plurality of candidate positions for assertion in the quantum circuit, where with respect to each of the candidate positions, the quantum circuit is divided into a first candidate section that is before the candidate position, and a second candidate section that is after the candidate position;
by the processor, for each of the candidate positions, determining one of a cost and effectiveness of the candidate position for inserting the assertion circuit at the candidate position; and
by the processor, selecting the asserting position from the candidate positions based on the cost and the effectiveness of each of the candidate positions.

11. The method as claimed in claim 10, wherein the determining of one of a cost and effectiveness of the candidate position for each of the candidate positions includes:
by the processor, performing circuit simulation based on the initial state of the main qubits and the first candidate section that is before the candidate position, so as to obtain a simulated test state of the main qubits that corresponds to the candidate position, and
by the processor, determining a sparsity of the simulated test state; and
wherein the selecting of the asserting position from the candidate positions includes: by the processor, selecting the asserting position from the candidate positions based on the sparsity of each of the simulated test states that respectively correspond to the candidate positions.

12. The method as claimed in claim 11, wherein the selecting of the asserting position includes:
calculating, for each of the candidate positions and based on the sparsity of the simulated test state corresponding to the candidate position, a success rate and an expected execution time in terms of the second state generated by a combination of the quantum circuit and the assertion circuit being accurate when the asserting position is the candidate position; and
selecting the asserting position from the candidate positions based on one of the success rate and the expected execution time calculated for each of the candidate positions.

13. A quantum circuit structure adapted for a quantum system, the quantum system including a set of main qubits and a first ancilla qubit, said quantum circuit structure comprising:
a quantum circuit including a first circuit section configured to change the main qubits from an initial state to a first state, and a second circuit section; and
an assertion circuit between said first circuit section and said second circuit section, and configured to detect whether the first state is erroneous based on a zero-amplitude set, and to indicate, using the first ancilla qubit, a result of detecting whether the first state is erroneous,
wherein the second circuit section is configured to change the main qubits from the first state to a second state when the first ancilla qubit indicates that the first state is not erroneous; and
wherein the zero-amplitude set includes a set of predefined zero-amplitude state components.

14. The quantum circuit structure as claimed in claim 13, wherein the first ancilla qubit has an initial value being a first value (v1), and the assertion circuit is configured to operate as a unitary operator satisfying
$${{U}_{a} ( \vert i 〉 ⊗ \vert v 1 〉}_{anc} ) = \{ \begin{matrix}{\vert i 〉 ⊗ \vert v 2 〉}_{anc} , & if i ∈ S ( \vert ψ 〉 ) \\ {\vert i 〉 ⊗ \vert v 1 〉}_{anc} , & otherwise\end{matrix} ,$$
where Uₐ is the assertion circuit, |i [symbol] is a basis state component of the first state of the main qubits, |v1 [symbol] _{anc} represents that the first ancilla qubit is in a state of |v1 [symbol] , |v2 [symbol] _{anc} represents that the first ancilla qubit is in a state of |v2 [symbol] , v2 is a second value that is different from the first value (v1), and S(|ψ [symbol] is the zero-amplitude set; and
wherein the first ancilla qubit indicates that the basis state component |i [symbol] of the first state is not erroneous when the first ancilla qubit is in the state of |v1 [symbol] , and indicates that the basis state component |i [symbol] of the first state is erroneous when the first ancilla qubit is in the state of |v2 [symbol] .

15. The quantum circuit structure as claimed in claim 13, further comprising:
an enhancement circuit configured to increase a quantity of zero-amplitude state components in the first state to obtain an enhanced first state; and
an inverse circuit configured to revert the enhanced first state to the first state for said second circuit section to use;
wherein said enhancement circuit is between said first circuit section and said assertion circuit, said inverse circuit is between said assertion circuit and said second circuit section, and said assertion circuit is configured to detect whether the first state is erroneous based on the enhanced first state and the zero-amplitude set.

16. The quantum circuit structure as claimed in claim 15, wherein the first state of the main qubits is represented by a state vector |a [symbol] that includes a plurality of vector components α₀ to α₂_{ⁿ}₋₁, where n represents a quantity of the main qubits, and
$$\vert ψ 〉 = {[ {α}_{0} , {α}_{1} , … , {α}_{{2}^{n} - 1} ]}^{T} ;$$
wherein for each k∈{0, 1, . . . , 2ⁿ−1}, a vector component αₖ represents a probability amplitude of a basis state component |k [symbol] , which is one of multiple basis state components of the first state, the basis state component |k [symbol] being expressed in binary having n bits, each of the n bits corresponding to a respective one of the main qubits;
wherein said enhancement circuit is configured to apply a Hadamard gate (H-gate) to a target qubit for those of the basis state components of the first state that correspond to a first pair of vector components (αₚ, α_{q}), where a first vector component αₚ and a second vector component α_{q} of the first pair of vector components (αₚ, α_{q}) come from the vector components α₀ to α₂_{ⁿ}₋₁ of the state vector |a [symbol] , the first vector component αₚ is either equal to or opposite to the second vector component α_{q}, p differs from q at only one bit position when p and q are represented in binary, and the only one bit position at which p differs from q corresponds to a target qubit that is one of the main qubits, so as to change one of the first vector component αₚ and the second vector component α_{q} to zero.

17. The quantum circuit structure as claimed in claim 16, wherein said enhancement circuit is configured to refrain from applying the H-gate to the target qubit for those of the basis state components of the first state that correspond to a second pair of vector components (αᵣ, αₛ), wherein a third vector component ar and a fourth vector component as of the second pair of vector components (αᵣ, αₛ) come from the vector components α₀ to α₂_{ⁿ}₋₁ of the state vector |a [symbol] , r differs from s at the only one bit position at which p differs from q when r and s are expressed in binary, and exactly one of the third vector component αᵣ and the fourth vector component αₛ is equal to zero.

18. The quantum circuit structure as claimed in claim 16, wherein the vector components α₀ to α₂_{ⁿ}₋₁ includes a fifth vector component αₓ and a sixth vector component α_{y}, the fifth vector component αₓ is either equal to or opposite to the sixth vector component α_{y}, and x differs from y at multiple bit positions when x and y are represented in binary; and
wherein said enhancement circuit is configured to apply at least one controlled NOT gate (CNOT-gate) to the main qubits to reduce a Hamming distance between x and y to one, so as to create more of the first pair of vector components (αₚ, α_{q}).

19. The quantum circuit structure as claimed in claim 15, wherein the first state of the main qubits is represented by a state vector |a [symbol] that includes a plurality of vector components α₀ to α₂_{ⁿ}₋₁, where n represents a quantity of the main qubits, and
$$\vert a 〉 = {[ {α}_{0} , {α}_{1} , … , {α}_{{2}^{n} - 1} ]}^{T} ;$$
wherein for each k∈{0, 1, . . . , 2ⁿ−1}, a vector component represents a probability amplitude of a basis state component |k [symbol] , which is one of multiple basis state components of the first state, the basis state component |k [symbol] being expressed in binary having n bits, each of the n bits corresponding to a respective one of the main qubits;
wherein said enhancement circuit is configured to apply a first z-axis rotation gate (R_{z}-gate) to a target qubit based on a first angle θₐᵢ, wherein the first angle θₐᵢ corresponds to a pair of vector components (α₂ᵢ, α₂ᵢ₊₁) that come from the vector components do to α₂_{^{n−1}} of the state vector |a [symbol] , i is an integer from zero to 2⁽ⁿ⁻¹⁾−1, and the target qubit is one of the main qubits;
wherein said enhancement circuit is configured to apply a first H-gate to the target qubit;
wherein said enhancement circuit is configured to apply a second R_{z}-gate to the target qubit based on a second angle θ_{bi} that corresponds to the pair of vector components (α₂ᵢ, α₂ᵢ₊₁); and
wherein said enhancement circuit is configured to apply a second H-gate to the target qubit.

20. The quantum circuit structure as claimed in claim 15, wherein the first state of the main qubits is represented by a state vector |a [symbol] that includes a plurality of vector components α₀ to α₂_{ⁿ}₋₁, where n represents a quantity of the main qubits, and
$$\vert ψ 〉 = {[ {α}_{0} , {α}_{1} , … , {α}_{{2}^{n} - 1} ]}^{T} ;$$
wherein for each k∈{0, 1, . . . , 2ⁿ−1}, a vector component αₖ represents a probability amplitude of a basis state component |k [symbol] , which is one of multiple basis state components of the first state, the basis state component |k [symbol] being expressed in binary having n bits, each of the n bits corresponding to a respective one of the main qubits;
wherein a pair of vector components (α₂ᵢ, α₂ᵢ₊₁) that come from the vector components do to α₂_{ⁿ}₋₁ of the state vector |a [symbol] corresponds to a predetermined first angle θₐᵢ and a predetermined second angle θ_{bi},
where
$${θ}_{ai} = {b}_{{ai}_{1}} \cdot \frac{2 π}{{2}^{1}} + {b}_{{ai}_{2}} \cdot \frac{2 π}{{2}^{2}} + ⋯ + {b}_{{ai}_{m}} \cdot \frac{2 π}{{2}^{m}} ,$$
$$where$$
$${θ}_{bi} = {b}_{{bi}_{1}} \cdot \frac{2 π}{{2}^{1}} + {b}_{{bi}_{2}} \cdot \frac{2 π}{{2}^{2}} + ⋯ + {b}_{{bi}_{m}} \cdot \frac{2 π}{{2}^{m}}$$
and where i is an integer from zero to 2⁽ⁿ⁻¹⁾−1, m is a positive integer, and for each integer j from 1 to m, bₐᵢ_{ⱼ}∈{0, 1}, and b_{bi}_{ⱼ}={0, 1};
wherein said enhancement circuit is configured to:
for each integer j from 1 to m, apply a first R_{z}-gate to a target qubit based on an angle of
$$\frac{2 π}{{2}^{j}}$$
for those of the basis state components of the first state that correspond to the pair of vector components (α₂ᵢ, α₂ᵢ₊₁) in response to bₐᵢ_{ⱼ}=1, wherein the target qubit is one of the main qubits,
apply a first H-gate to the target qubit,
for each integer j from 1 to m, apply a second R_{z}-gate to the target qubit based on an angle of
$$\frac{2 π}{{2}^{j}}$$
for those of the basis state components of the first state that correspond to the pair of vector components (α₂ᵢ, α₂ᵢ₊₁) in response to b_{bi}_{ⱼ}=1, and
apply a second H-gate to the target qubit.
